(19) United States
(12) Patent Application Publication
(10) Pub. No.: US 2005/0236754 A1
(43) Pub. Date: Oct. 27, 2005

(54) Work carrier

(75) Inventors: Shinsuke Sugata, Fukuyama-shi (JP); Yasuhito Oohira, Ibara-shi (JP); Toshihiko Amako, Fukuyama-shi (JP)

Correspondence Address: John P. Shannon;Merek, Blackmom & Voorhees, LLC, 673 South Washington Street, Alexandria, VA, 22314, US

(73) Assignee: Horkos Corp., Fukuyama-shi (JP)

(21) Appl. No.: 10/510,352

(22) PCT Filed: Apr. 10, 2003
(86) PCT No.: PCT/JP03/04591

§ 371 Date: Oct. 6, 2004

(30) Foreign Application Priority Data
Apr. 12, 2002 (JP) 2002-110810

(51) Int. Cl. B23Q 1/64

(52) U.S. Cl. 269/56

(57) ABSTRACT

A work carrier capable of moving a work stage 45 to an arbitrary position in the left/right direction and stopping the work stage 45 thereat with an accuracy equivalent to that of a conventional carrier or above through an inexpensive structure. The work carrier comprises a fixed guide rail member 15 and movable guide rail members 17, 18, 19 mounted on a supporting table 10, a driver 16 for moving the movable guide rail members to the left and the right, rail member interlocking mechanisms 35a, 35b for interlockingly operating the movable guide rail members 17, 18, 19, and the work stage 45 mounted on the movable guide rail member 19, wherein the driver 16 is a motor having a rotational speed being varied by inverter control and employing an open loop rotation control system, and a plurality of stopper members 52a, 52b, 52c are provided in order to stop the movable guide rail member 17 at a specified position.

### TECHNICAL FIELD

The present invention relates to a work carrier with a plurality of movable guide rail members buckling laterally in multistage, which is used for carrying a work of a machine tool.

### PRIOR ART

A work carrier as disclosed in Japanese Patent Publication No. 1993-90760 has already existed. The work carrier comprises a fixed guide rail member mounted on a support table for left and right and three movable guide rail members accumulated thereon. A servomotor is provided to displace the lowest movable guide rail member to the left/right direction. Besides, a rail member interlocking mechanism is provided to make the upper movable guide rail members jut greatly to the left/right direction in connection with movement of the lowest movable guide rail member. Moreover, a work stage is provided so as to move in a left/right direction on the highest movable guide rail member in connection with its movement.

In this case, the servomotor is numerically controlled by a semi-closed loop rotation control system according to data of a rotation detector for detecting rotational displacement thereof before being inputted into a reduction gear. Besides, its rotations are communicated to a mechanism for interlocking the movable guide rail members and the work stage through the reduction gear.

The present invention aims to provide a work carrier capable of displacing a work to an arbitrary position with an accuracy equivalent to that of a conventional carrier or above on following a basic structure of the work carrier described in the Japanese Patent Publication No. 1993-90760 except for the servomotor.

### SUMMARY OF THE INVENTION

To achieve the above-mentioned aim, a work carrier of the present invention is constructed as following. That is, the work carrier comprises a fixed guide rail member mounted on a support table for left and right, at least more than two movable guide rail members accumulated on the fixed guide rail member, a rotation drive unit for displacing the lowest movable guide rail member to the left/right direction through a gear racking mechanism, a rail member interlocking mechanism for operating so that the movable guide rail members may greatly jut to either of the left and the right in an order from the lower in connection with movement of either of the left and the right from its center of the lowest movable guide rail member, and a work stage moving in the left/right direction on the highest movable guide rail member in connection with its movement. And therein, the drive unit serves as a motor having a rotational speed being varied by inverter control and employing an open loop rotation control system. Besides, the drive unit is provided with a plurality of stopper members impacting each other to stop any of the 0 movable guide rail members at a position corresponding to a carrier starting point or a carrier finishing point of the work stage. The work stage is displaced to an arbitrary position between the carrier starting point and the carrier finishing point.

In this invention, in case the work stage automatically stops at an arbitrary specified position between the carrier starting point and the carrier finishing point, when it approaches at the specified position to be stopped, the motor is controlled by the inverter control so as to reduce the rotational speed enough, and when it arrives there, the motor is controlled so as to reduce it to zero. Therefore, when the work stage approaches at the specified position, it very slowly moves and exactly stops without receiving inertia force during its movement.

Since the stopper members impact each other at the carrier starting point and at the carrier finishing point to compulsorily stop the work stage, the work stage can stop more exactly.

The above-mentioned invention is defined as follows.

The stopper members comprise a movable stopper member fixed integrally with the lowest movable guide rail member and a fixed stopper member fixed integrally with the support table, so constructed that the lowest movable guide rail member can stop at positions corresponding to the carrier starting point and the carrier finishing point on impact between the movable stopper member and the fixed stopper member.

Accordingly, it is unnecessary to provide with any stopper member to any position except for the lowest movable guide rail member and the support table. And, it becomes easy to secure and control a space for the stopper member.

Besides, a reduction gear, a driving pinion, a movable rack for left and right and a displacement detector are provided. Here, rotations of an output axis of the motor are inputted into the reduction gear. The driving pinion is interlockingly connected with the output axis of the reduction fear, and freely rotates at a specified position of the support table along its vertical surface. The movable rack for left and right is interlocked with the pinion and fixed on the lowest movable guide rail member. The displacement detector detects an operating displacement of the output axis of the reduction gear on a path for communicating displacement based on the rotations of the motor or an operating displacement of the arbitrary position by the side of a communicating displacement terminus from the output axis.

According to this, the work stage is detected through the detector. In this case, since the detected results do not include errors caused by the reduction gear which occasionally causes a large error to the operating displacement of the work stage because backlash of a plurality of gears are accumulated. Therefore, the work stage is exactly position-controlled through the detector in accordance with the detected data.

A tooth of the movable rack is inclined to front and rear within the face width thereof. Besides, the driving pinion serves as a bevel gear having a tooth to be interlocked to the tooth of the movable rack, fixed on the rotating central axis so as to changeably adjust a position in the front/rear direction.

According to this, floating clearances in places where the tooth of the driving pinion is interlocked with the tooth of the movable rack increase or decrease by changing front and rear position of the driving pinion.

Moreover, the rail member interlocking mechanism comprises a fixed rack long in the left/light direction, movable racks long in the left/right direction and interlocking pinions. Here, the fixed rack is fixed on the fixed guide rail member, and the movable racks are respectively fixed on the movable guide rail members. And, the interlocking pinions are mounted at the specified places of the movable guide rail members except for the highest movable guide rail member rotatively around axes for front and rear. And therein, the movable rack or the fixed rack is correspondingly interlocked with the top or the bottom of each interlocking pinion. In this case, the tooth of the movable rack and the tooth of the fixed rack are inclined to the front/rear direction within the face width, and the interlocking pinions serve as bevel gears for interlocking with the tooth of the movable rack. The axes for front and rear corresponding to the interlocking pinions are formed of fixed axes for front and rear fixedly mounted on the corresponding movable guide rail members and eccentric cylindrical axis members external-insertedly fixed thereon for changeably adjusting angles around them. Besides, the interlocking pinions have the front and rear positions on the corresponding axes for front and rear adjusted and changed, respectively.

In thus construction, the former clearance, which is the floating clearance in the engaging position between the lower tooth of an arbitrary interlocking pinion and the tooth of the fixed rack or the movable rack, and the latter clearance, which is the floating clearance in the engaging position between the upper tooth of the interlocking pinion and the tooth of the movable rack, are mostly increased in different states each other by progress of time using the present device. However, to cope with this, angle positions of the eccentric cylindrical axis members are exchanged to identify the former clearance and the latter clearance, and besides, the arbitrary interlocking pinion is longitudinally displaced to the side where their clearances decrease. Therefore, both the former clearance and the latter clearance are decreased in desirable sizes, respectively.

When the former clearance and the latter clearance are increased in a same size, their clearances are decreased in a desirable size only by longitudinally displacing the arbitrary interlocking pinion to the side where their clearances decrease.

### BRIEF DESCRIPTION OF THE DRAWINGS

FIG. 1 is a front view showing a process line with a work carrier related to the present invention, and

FIG. 2 is a right side view of the process line.

FIG. 3 is a front view showing a carrier start state and a carrier finish state of the work carrier,

FIG. 4 is a front view showing an initial state of the work carrier, and

FIG. 5 is a partially vertical sectional view of the work carrier.

FIG. 6 shows an eccentric cylindrical axis member of the work carrier, FIG. 6A is a side view and FIG. 6B is a front view.

FIG. 7 shows a structure that an interlocking pinion is mounted to the work carrier, FIG. 7A is a plane view and FIG. 7B is a front view.

FIG. 8 is a sectional view at side sight, which shows the structure that the interlocking pinion is mounted on the work carrier, and

FIG. 9 is an explicative view showing position control of the interlocking pinion.

FIG. 10 is a front view showing a state that stopper members are mounted on the work carrier,

FIG. 11 is a side view thereof and

FIG. 12 is a plane view thereof.

FIG. 13 is a plane view showing a modification of the state that stopper members are mounted on the work carrier.

### PREFERRED EMBODIMENT OF THE INVENTION

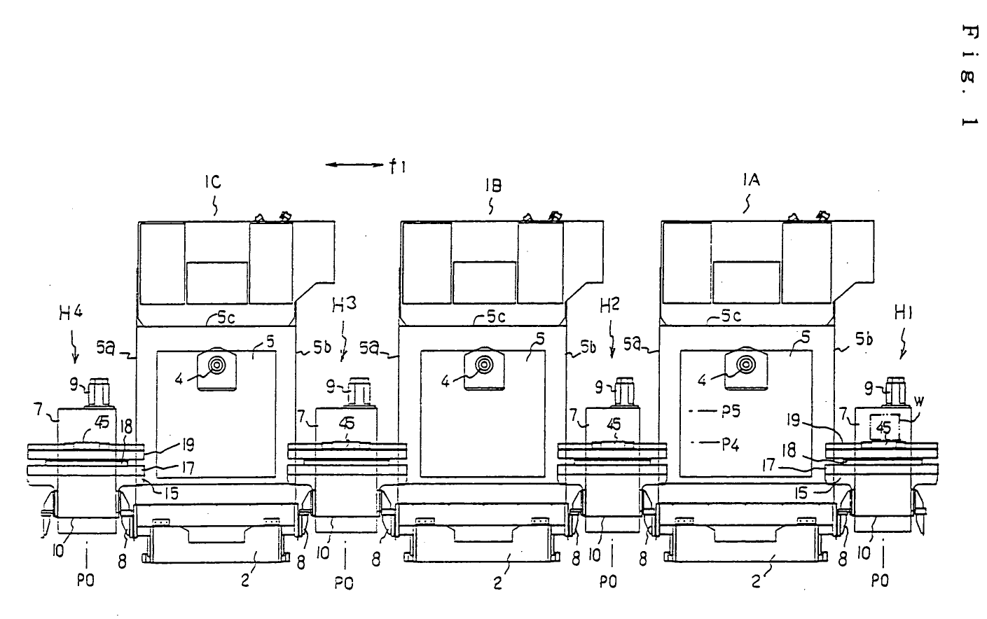

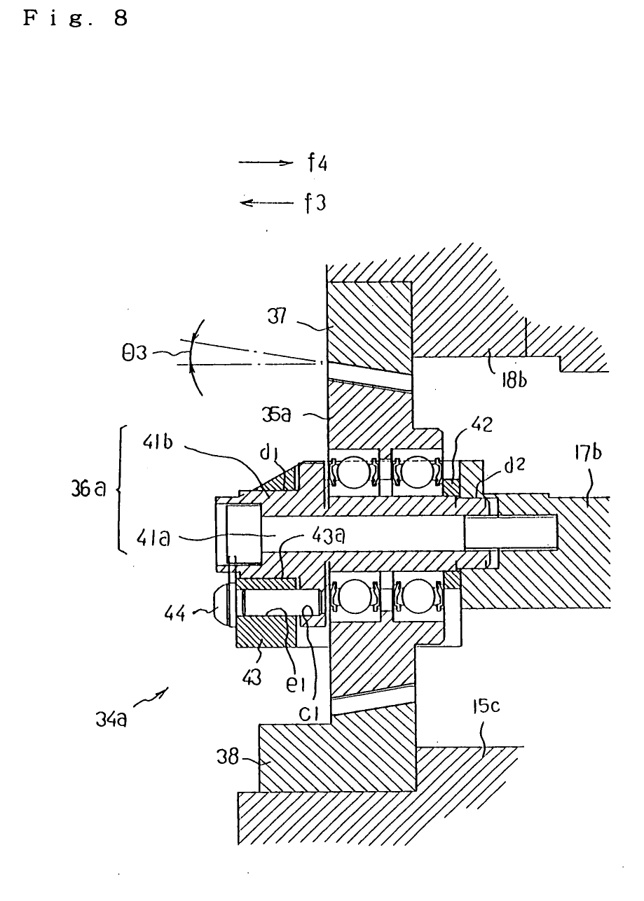

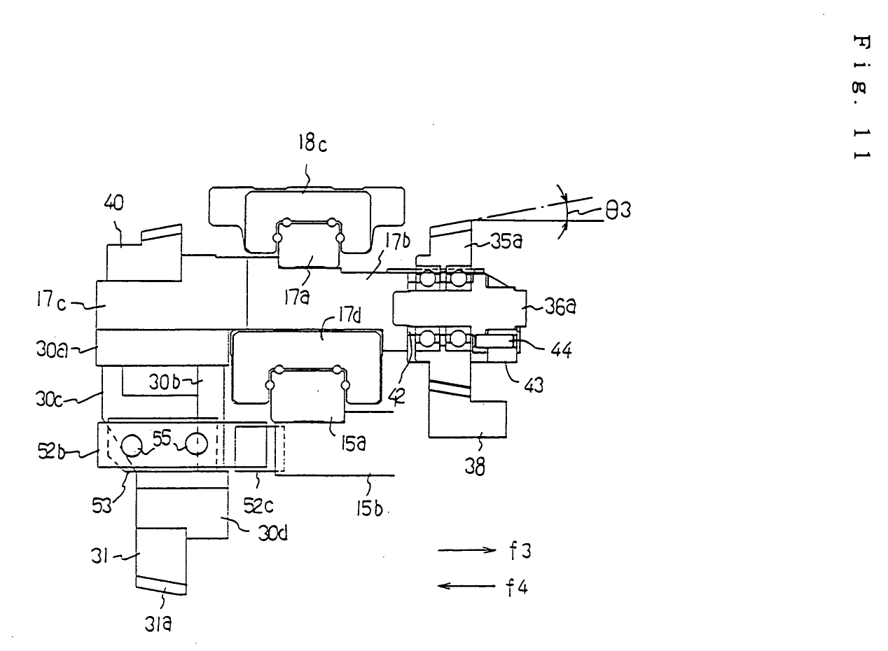

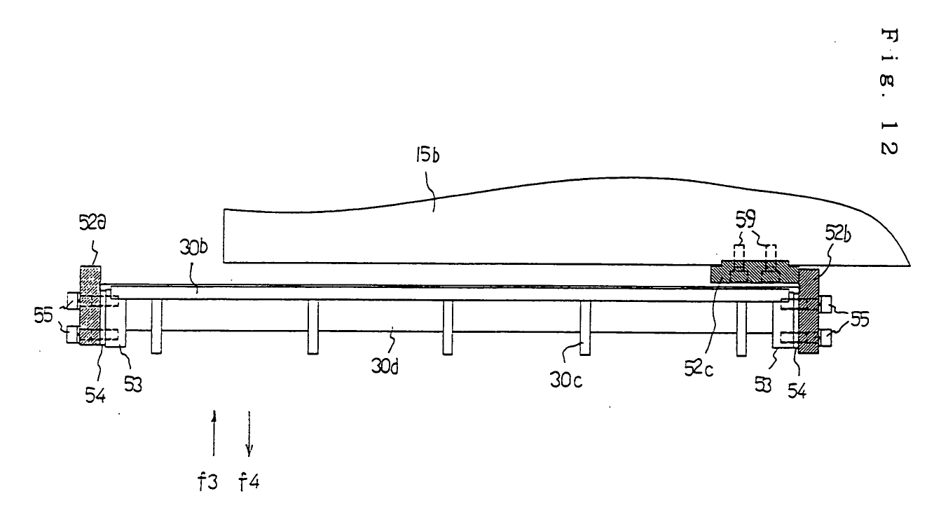

FIGS. 1 to 13 show a process line with a work carrier related to the present invention. An embodiment of the present invention will be explained as follows with reference to these drawings.

In FIGS. 1, 1A, 1B and 1C are three machining centers arranged at a suitable interval.

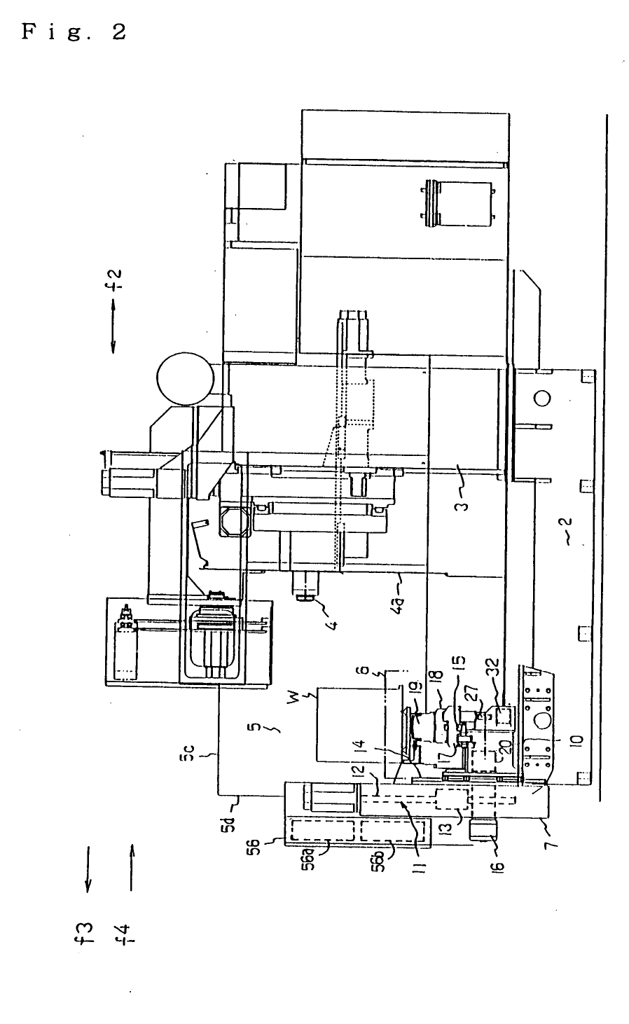

Each of machining centers 1A, 1B and 1C is so constructed that a column 3 is fixed on the top of a base table 2, a spindle 4 is mounted on the column 3 movably in a vertical, lateral and longitudinal direction, and a closed machining space 5 for machining a work w is formed upward the base table 2 and forward the column 3 as shown in FIG. 2.

In this case, the closed machining space 5 is surrounded by left and right side walls 5a, 5b, a ceiling wall 5c, a front wall 5d shown in FIG. 2 and a standing cover for left and right 4a formed forward the column 3.

A work-fixing device 6 is provided in the closed machining space 5, and so constructed as to automatically cancel fixation of the fixed work w at arbitrary time. In thus cancelled state, when the work w is pushed up upward, it gets out of a not-illustrated work-positioning pin to be free. Work carriers H1, H2, H3, H4 related to the present invention are fixed on sides 5a, 5b of the base tables 2 of machining centers 1A, 1B, 1C, respectively.

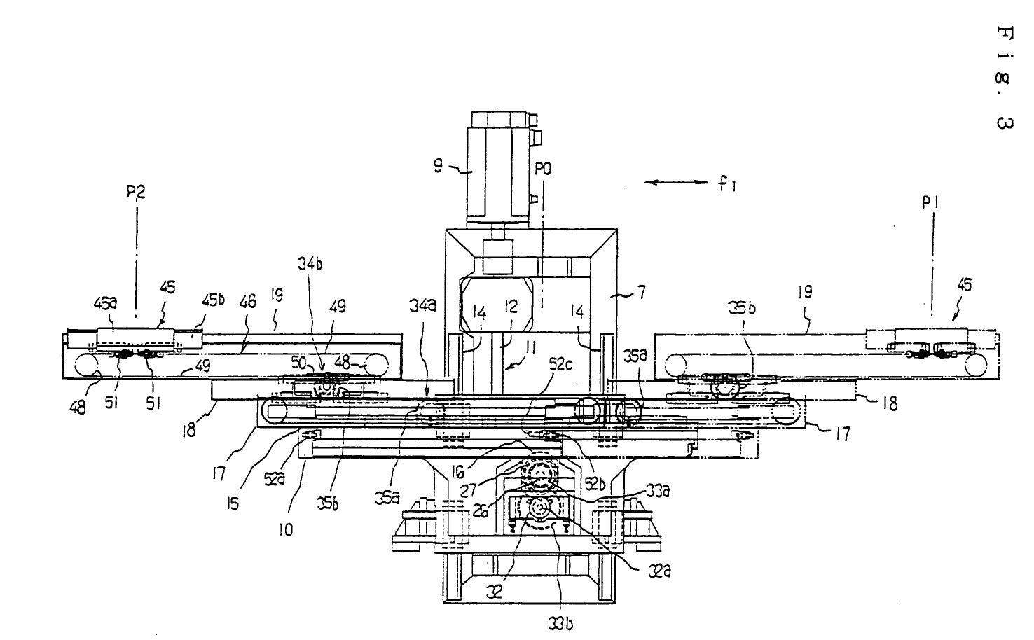

An explanation about one of these work carriers H1, H2, H3, H4 will be as follows. Numeral 7 is a fixed table having a rectangular frame shape long in the left/right direction, which is fixedly bolted to the base table 2 through coupling members 8. A general motor 9 (a lead motor) for climbing-driving is vertically fixed on the top of the fixed table 7. A support table 10 vertically operates through a vertical feed mechanism 11 by rotations of the motor 9. The vertical feed mechanism 11 is shown in FIG. 3 and so on.

The vertical feed mechanism 11 comprise a vertical thread axis 12, a nut body 13 and a pair of left and right vertical guide rails 14, 14 as shown in FIGS. 2, 3. The vertical thread axis 12 rotates at a fixed height position due to the motor 9. The nut body 13 is integrally fixed on the support table 10, and the vertical tread axis 12 is screwed therein. The vertical guide rails 14, 14 are fixed on the fixed table 7 and guide the support table 10 in a vertical direction.

On the support table 10, as shown in FIGS. 3 to 5, are fixed a horizontal fixed guide rail member 15 long in a left/right direction f1 and a crossfeed general motor 16 (a lead motor) toward a front/rear direction f2. Three movable guide rail members 17, 18, 19 are accumulated over the fixed guide rail member 15. Each of them is guided to any of the just lower fixed guide rail member 15 or movable guide rail members 17, 18 displaceably in the left/right direction f1.

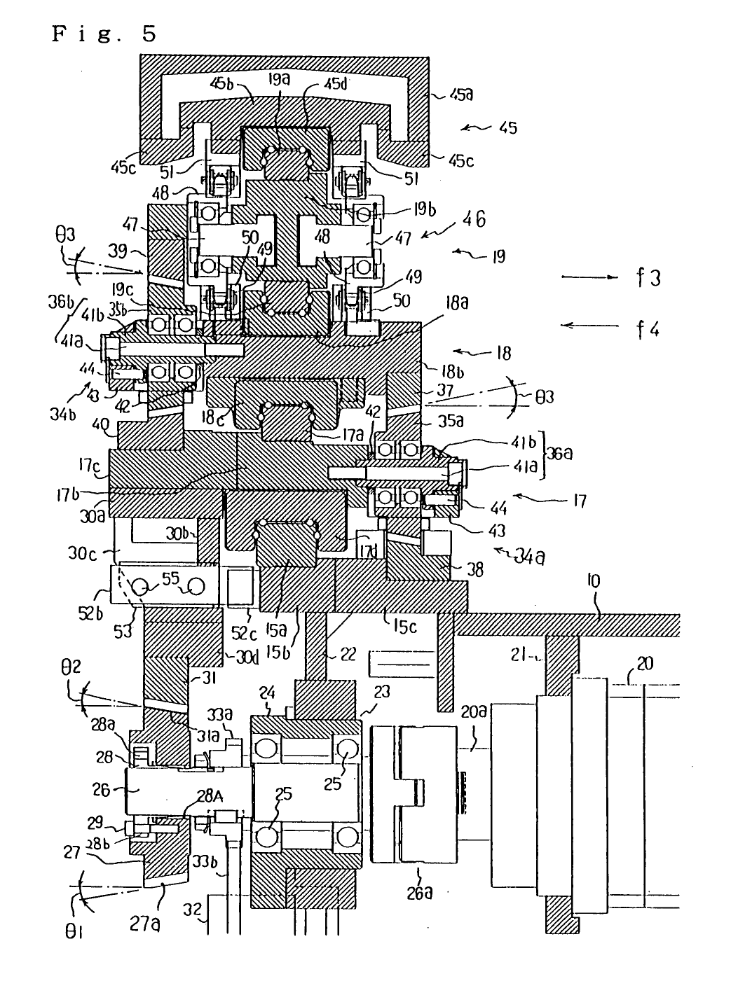

In this case, as shown in FIG. 5, the fixed guide rail member 15 comprises a rail body for left and right 15a, a member 15b for supporting the rail member 15a and a member 15c for combining the member 15b with the support table 10. The movable guide rail member 17 comprises a rail member for left and right 17a, a member 17b for supporting the rail member 17a, a member 17c fixed on the front of the member 17b and a channel member 17d fixed on the bottom of the member 17c and guided to the rail member 15a. The movable guide rail member 18 comprises a channel member 18a, a member 18b for supporting the channel member 18a and a channel member 18c fixed on the bottom of the member 18b to be guided the rail member 17a. The movable guide rail member 19 comprises a rail member for left and right 19a, a member 19b for supporting the rail member 19a and a rail member for left and right 19c fixed on the bottom of the member 19b to be guided to the channel member 18a. The rail members 15a, 17a, 19c and the channel members 17d, 18c, 18a to be interlocked therewith are smoothly-relatively displaced through a large number of balls.

In FIGS. 2, 5, the lowest movable guide rail member 17 is driven to the left/right direction f1 by the general motor 16, and it is explained in detail as follows.

A reduction gear 20 for being inputted rotations of the motor 16 is fixedly mounted on the rear of the general motor 16 shown in FIG. 2 through a fitting member 21 fixed on the support table 10 as shown in FIG. 5. A bearing 23 is fixedly mounted on the rear side f4 of the reduction gear 20 through a fitting member 22 fixed on the bottom of the member 15b composing the fixed guide rail member 15. In this case, the bearing 23 is provided with a cylindrical member 24 integrally fixed with the fitting member 22 and a pair of front and rear ball bearings 25, 25 mounted inside the cylindrical member 24.

A rotating central axis for front and rear 26 is mounted on the bearing 23 through the bearings 25, 25 rotatively at a fixed position. The front end of the rotating central axis 26 is combined with an output axis 20a through a universal coupling 26a absorbably in center displacement, and a driving pinion 27 is fixed on the rear end the rotating central axis 26 changeably in its front and rear position. In this case, 28 is a cylindrical male wedge whose flange is provided with a thread hole 28a into which a push bolt is screwed and a through hole 28b into which a fixed bolt 29 screwed to the driving pinion 27 is inserted. Numeral 28A is a cylindrical female wedge changeably in enlarging diameter, which is externally interfitted to the cylindrical male wedge 28. The driving pinion 27 forms in bevel gear, and an inclination θ1 of face width of the top of the tooth 27a, namely, the front/rear direction f2 is about 10 degree as compared with a horizontal plane.

On the other hand, a board member 30a long in the left/right direction f1 is fixed on the bottom of the member 17c composing the lowest movable guide rail member 17 along the horizontal plane. A vertical board member 30b long in the left/right direction f1 is fixed on the lower front edge of the board member 30a. And besides, a plurality of vertical reinforcing aggregate members 30c are fixed on the bottom of the board member 30a at the rear side f4 of the board member 30b. A fixture member 30d long in the left/right direction f1 is fixed on the lower end of the aggregate member 30c and the lower end of the board member 30b along the horizontal plane. And a downward movable rack 31 long in the left/right direction f1 is fixed on the bottom of the fixture member 30d. The top of the tooth 31a of the rack 31 is inclined in the front/rear direction of face width in connection with the tooth 27a of the driving pinion 27, and this inclination θ2 is about 10 degree as compared with the horizontal plane as same as the case of the driving pinion 27. The tooth 31a of the movable rack 31 is interlocked to the tooth 27a of the driving pinion 27, and a floating clearance in the interlocking between the tooth 31a and the tooth 27a (backlash and so on) is adjusted to less than 0.04 mm when the tooth 31a and the tooth 27a are opposite.

The floating clearance is adjusted and changed in the manner of varying the height of the movable rack 31 to the lowest movable guide rail member 17 due to varying the thickness of an adjustable shim or in the manner of varying the front and rear position of the driving pinion 27 against the rotating central axis 26.

In thus construction, the rotations of the motor 16 are transmitted to the reduction gear 20. And thus reduced rotations are transmitted to the rotating central axis 26 and the driving pinion 27. Then, rotations of the driving pinion 27 interlockingly displace the lowest movable guide rail member 17 to the left/right direction through the movable rack 31. In this case, the lowest movable guide rail member 17 is smoothly displaced linearly in the left/right direction on a specified position due to guiding actions of the guide rail member 15a, the channel member 17d and globes inserted therebetween.

As shown in FIGS. 2 and 3, a rotary encoder 32 of displacement detector for detecting number of rotations of the rotating central axis 26 is provided below the driving pinion 27 integrally with the support table 10. An input axis 32a of the rotary encoder 32 is interlockingly connected with the rotating central axis 26 through a gear transmitting mechanism comprising a driving gear 33a and a driven gear 33b. In this case, the driving gear 33a is fixed on the rotating central axis 26, and the driven gear 33b is fixed on the input axis 32a.

As shown in FIG. 5, the fixed guide rail member 15 and the movable guide rail members 17, 18, 19 are interlockingly connected with one another through rail member interlocking mechanisms 34a, 34b. Here, the rail member interlocking mechanisms 34a, 34b operate so that the upper one of movable rail members 17, 18, 19 protrudes more greatly in the left/right direction f1 in connection with the displacement of the movable guide rail member 17. The rail member interlocking mechanisms 34a, 34b will be explained as follows.

As shown in FIGS. 3 to 6, interlocking pinions 35a, 35b are rotatively mounted on the centers of the movable guide rail members 17, 18 in the lateral direction through the axes for front and rear 36a, 36b and a pair of front and rear bearings, respectively. Either of the interlocking pinions 35a, 35b is formed in a bevel gear in accordance with the driving pinion 27. An inclination θ3 of face width of the top of the tooth is about 10 degree as compared with the horizontal plane.

A downward movable rack 37 long in the left/right direction and an upward fixed rack 38 long in the left/right direction f1 are interlocked with the top and the bottom of the interlocking pinion 35a mounted on the lowest movable guide rail member 17, respectively. The movable rack 37 is fixed on the lower front edge of the member 18b composing the middle movable guide rail member 18. The fixed rack 38 is fixed on the top of the member 15c composing the fixed guide rail member 15. The top of the tooth of each racks 37, 38 is inclined in the front/rear direction of face width in connection with the tooth of the interlocking pinion 35a. This inclination is in about 10 degree as compared with the horizontal plane as well as the interlocking pinion 27.

Besides, a downward movable rack 39 long in the left/right direction f1 and an upward fixed rack 40 long in the left/right direction f1 are interlocked with the top and the bottom of the interlocking pinion 35b of the middle movable guide rail member 18, respectively. The movable rack 39 is fixed on the lower rear edge of the member 19b composing the highest movable guide rail member 19. The fixed rack 40 is fixed on the top of the member 17c composing the lowest movable guide rail member 17. The top of each tooth of these racks 39, 40 is inclined in the front/rear direction of face width in accordance with the tooth of the interlocking pinion 35b. This inclination is in about 10 degree as compared with the horizontal plane as well as the interlocking pinion 36a.

The axes for front and rear 36a, 36b rotatively supporting the interlocking pinions 35a, 35b are formed of fixed axes for front and rear 41a and eccentric cylindrical axis members 41b. Here, the fixed axes 41a are screwed in and fixed on the members 17b, 18b of the corresponding movable guide rail members 17, 18 and the eccentric cylindrical axis members 41b are externally inserted to the fixed axes 41a and changeably adjust angles around them. Besides, the interlocking pinions 35a, 35b changeably adjust the front and rear positions on the corresponding axes 36a, 36b due to varying the thickness of a thickness control ring 42 externally inserted to the eccentric cylindrical axis members 41b, respectively.

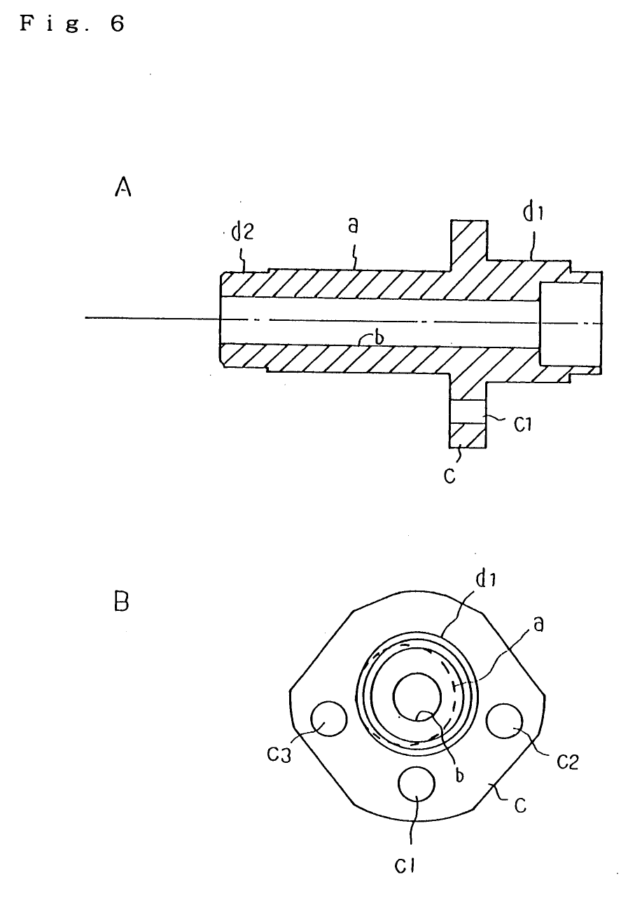

In this case, the fixed axes 41a include head parts for preventing the eccentric cylindrical axis members 41b from slipping out and thread parts for being screwed in the movable guide rail members. As shown in FIG. 6, the eccentric cylindrical axis member 41b comprises a right circular peripheral part a and a straight cylindrical hole b. Here, a central line of the straight cylindrical hole b is what parallely displaces a central line of the peripheral part a to the radial direction, for example, by about 0.1 mm. Besides, the eccentric cylindrical axis member 41b has a flange part c and a short right circular peripheral part d1 concentrically with the cylindrical hole b at the front edge, and a short right circular peripheral part d2 concentrically with the cylindrical hole b at the bottom edge.

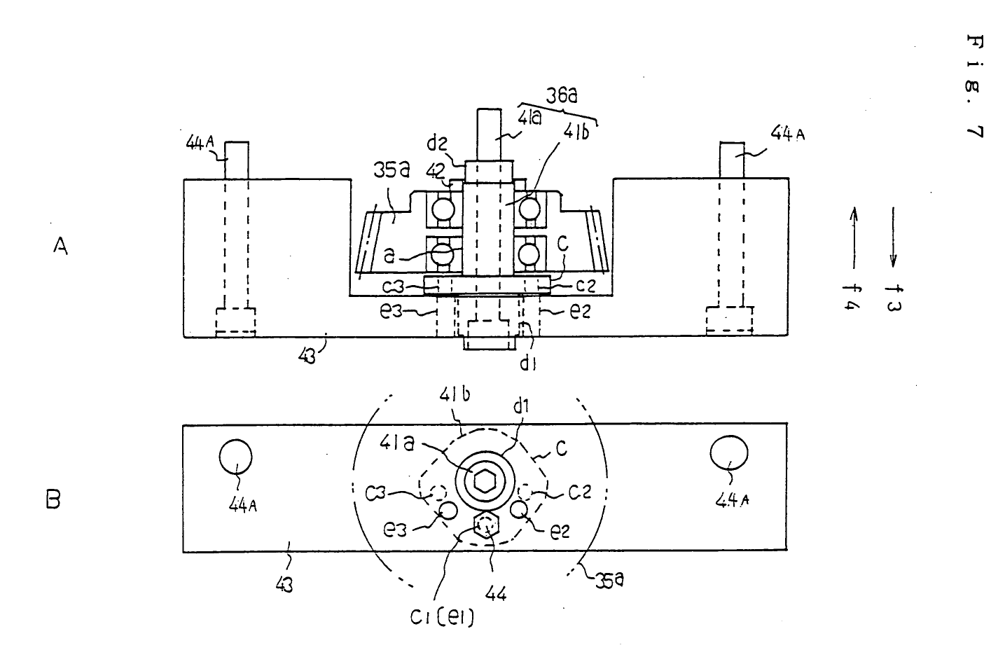

The tips of the axes for front and rear 36a, 36b are supported to a frame member 43 in angular C letter shape at plane view, which is fixed on the movable guide rail members 17, 18 through bolts 44A shown in FIG. 7. The frame member 43 has a through hole 43a for being interfitted the right circular peripheral part d1 at the center of the lateral length, and three comparatively small through holes e1, e2, e3 for being inserted bolts 44 which are alternatively screwed in thread holes c1, c2, c3 formed to the flange c of the eccentric cylindrical axis member 41b as shown in FIG. 6B.

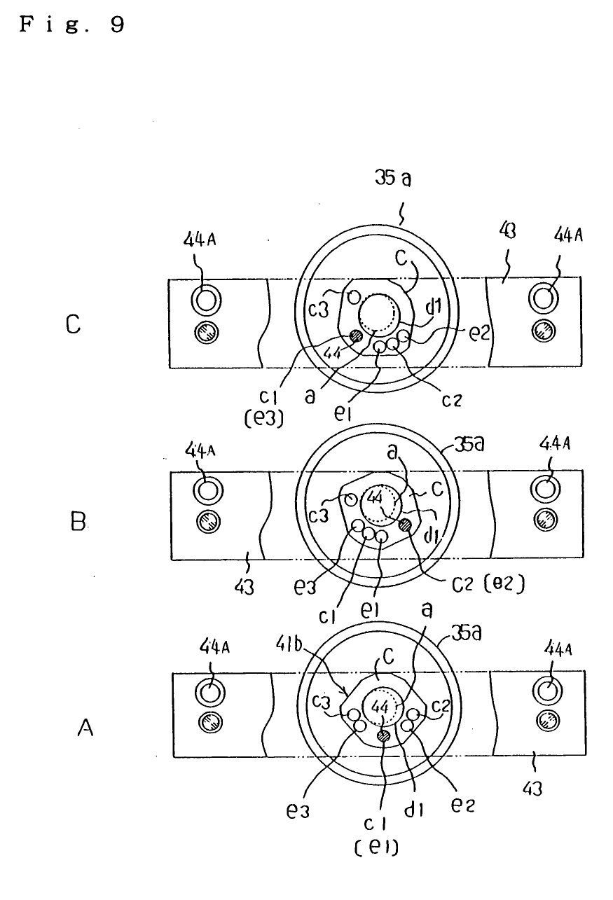

Each tooth of the interlocking pinions 35a, 35b is interlocked with each tooth of movable racks 37, 39 or the fixed racks 38, 40. The floating clearance (backlash and so on) of the tooth is adjusted so as to be less than 0.04 mm under a basic state (as shown in FIG. 9C) where vertical eccentricities of the interlocking pinions 35a, 35b against the centers of the fixed axes 41a are zero.

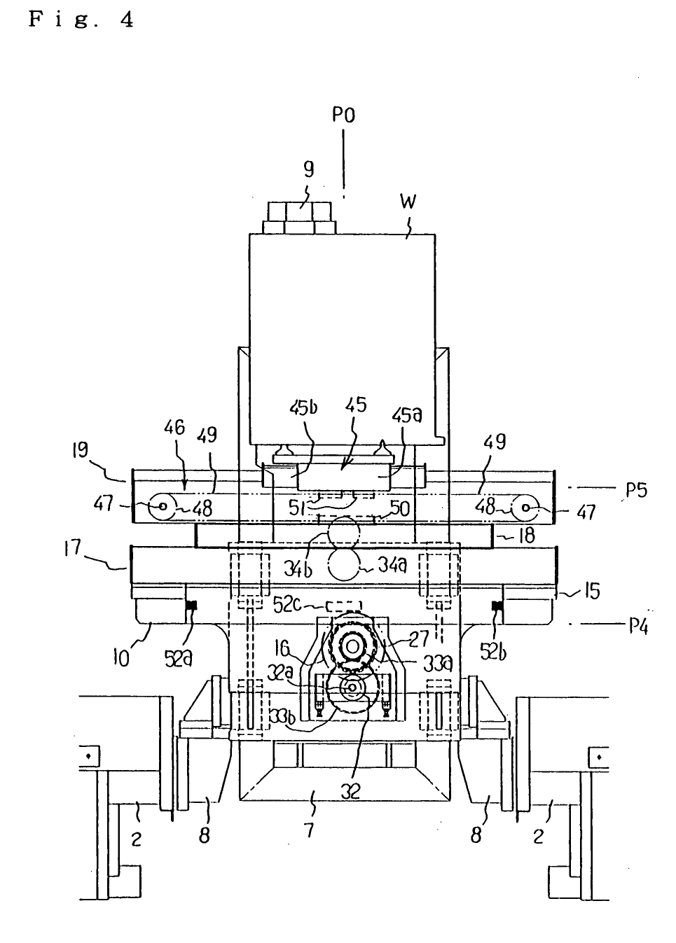

In thus constructed rail member interlocking mechanisms 34a, 34b in FIG. 5, when the lowest movable guide rail member 17 is situated at the center (neutral point) p0 of the length in the left/right direction f1 of the support table 10 as shown in FIG. 4, the other movable guide rail members 18, 19 are situated at neutral points p1, respectively. When the lowest movable guide rail member 17 is displaced to either of the left/right direction f1, the fixed rack 38 rotates the interlocking pinion 35a around the axis 36a based on relative displacement between the movable guide rail member 17 and the fixed guide rail member 15. The rotation of the interlocking pinion 35a displaces the movable rack 37 fixed on the middle movable guide rail member 18 to the displacement direction of the lowest movable guide rail member 17 together with the movable guide rail member 18. Then, the fixed rack 40 rotates the interlocking pinion 35b mounted on the middle movable guide rail member 18 around the axis 36b based on the relative displacement between the middle movable guide rail member 18 and the lowest movable guide rail member 17. The rotation of the interlocking pinion 35b displaces the movable rack 39 fixed on the highest movable guide rail member 19 to the displacement direction of the middle movable guide rail member 18 together with the movable guide rail member 19. According to thus displacement, the movable guide rail members 17, 18, 19 jut toward their displacement direction more greatly in due orders from the lower as shown in FIG. 3.

As shown in FIG. 5, a work stage 45 is guided to the highest movable guide rail member 19 through the rail member 19a displaceably in the left/right direction f1. The work stage 45 comprises a table member 45a having a plane top, an underside-supporting member 45b arranged below the table member 45a, a pair of front and rear binding members 45c, 45c combining these members 45a, 45b, and a channel member 45d. The channel member 45d is fixed on the center in the front/rear direction of the bottom of the underside-supporting member 45b, and besides, guided in the left/right direction f1 through the rail member 19a.

Between the work stage 45 and the highest movable guide rail member 19, is provided a chain interlocking mechanism 46 for displacing the work stage 45 in connection with the lateral displacement of the movable guide rail member 19.

In the chain interlocking mechanism 46, a pair of front and rear and a pair of left and right sprockets 48, 48 are mounted on left and right ends of the highest movable guide rail member 19 rotatively around the supporting axes 47, 47 as shown in FIGS. 4, 5. In the front and rear of the movable guide rail member 19, a pair of left and right chains 49, 49 are hung and turned to the corresponding sprockets 48, 48 in horizontal U letter shape. The underside edges of the chains 49, 49 are fixed about on the center of the lateral length of the highest movable guide rail member 19 through chain fixing blocks 51. Besides, the upside edges thereof are fixed on the underside-supporting member 45b through tensile fixtures 51 as the chains 49, 49 receive tension by springs. When the highest movable guide rail member 19 is displaced to one side of the left/right direction f1, the chains 49, 49 at the front and rear of the movable guide rail member 19 are stretched by the chain fixing blocks 50 and displace the work stage 45 to the displacement direction. On the other hand, the other side chains 49, 49 at the front and rear of the movable guide rail member 19 are stretched by the tensile fixtures 51 to be displaced.

As shown in FIG. 3, when the highest movable guide rail member 19 is displaced to the right by a fixed length, the work stage 45 arrives at a carrier starting point p1. Conversely, when it is displaced to the left by a fixed length, the work stage 45 arrives at a carrier finishing point p2. Besides, an impact stopper means comprising a plurality of stopper members 52a, 52b, 52c is provided to prevent the work stage 45 from being displaced to right or left over these points p1, p2 after arriving at the carrier starting point p1 or the carrier finishing point p2 from the neutral point p0, as shown in FIG. 4.

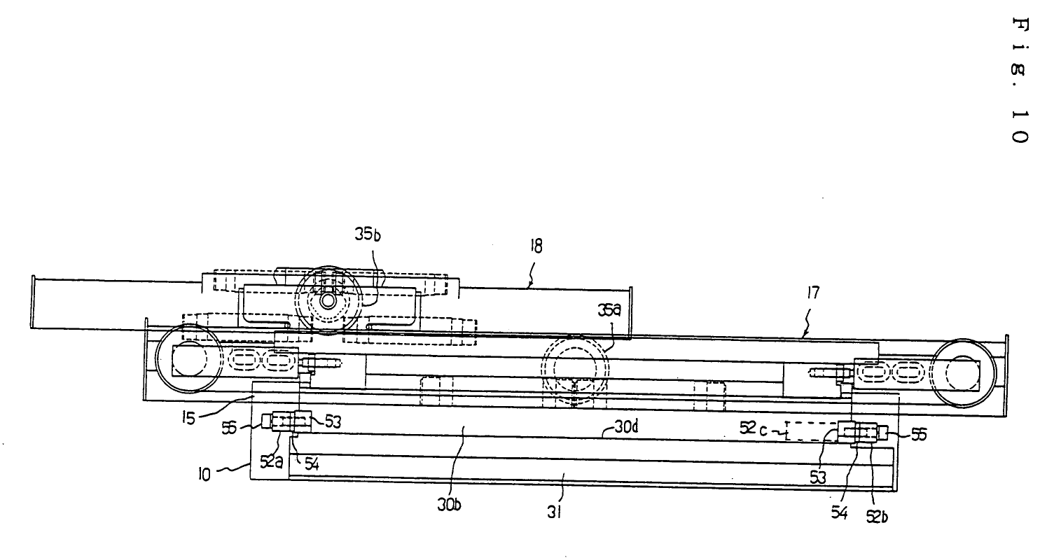

Among a plurality of stopper members 52a, 52b, 52c, the stopper members 52a, 52b serve as movable stopper members fixed integrally with the lowest movable guide rail member 17, and the stopper member 52c serves as a fixed stopper member fixed integrally with the support table 10. In this case, the movable stopper members 52a, 52b form into a rectangular parallelepiped for front and rear, and as shown in FIGS. 10 to 12, they are fixed on the outsides of fixtures 53, 53 so as to jut in the forward f3 through two bolts 55, 55 and a shim 54 for adjusting position in the left/right direction. Here, the fixtures 53, 53 are fixed on the tops of the left and right edges of the fixture member 30d integrally with the lowest movable guide rail member 17. Besides, the fixed stopper member 52c forms into a rectangular parallelepiped for left and right, fixed on the front edge of the center of the lateral length of the member 15b forming the fixed guide rail member 15 through two bolts 59, 59.

In thus impact stopper means, when the lowest movable guide rail member 17 is displaced to the right from the neutral point p0 and arrives at a position corresponding to the carrier starting point p1 of the work stage 45, the forward right side face of the left movable stopper member 52a impacts against the left end face of the fixed stopper member 52c. Therefore, the movable guide rail member 17 is regulated from further right displacement. Besides, when the lowest movable guide rail member 17 is displaced to the left from the neutral point p0 and arrives at a position corresponding to the carrier finishing point p2 of the work stage 45, the forward left side face of the right movable stopper member 52b impacts against the right edge face of the fixed stopper member 52c. And therefore, the movable guide rail member 17 is regulated from further left displacement.

A controller 56 comprising a control circuit mechanism 56a of the general motor 9 and a control circuit mechanism 56b of the general motor 16 is provided on the fixed table 7 of each work carrier as shown in FIG. 2. A control system in the control circuit mechanisms 56a, 56b is an open loop system as shown in the following.

The control circuit mechanism 56a is constructed so as to vertically displace the support table 10 due to controlling the general motor 9 and stop it at a descent point p4 and an ascent point p5 in FIG. 1.

The control circuit mechanism 56b is constructed so as to stop the work stage 45 at the carrier starting point p1 and the carrier finishing point p2 and besides an arbitrary position therebetween due to controlling the general motor 16 based on data detected by the rotary encoder 32. In this case, to exactly stop the work stage 45 at an arbitrary desirable specified position, the general motor 16 has rotations controlled based on an inverter control. For example, a driving current of the motor 16 is 30 cycle/second in an ordinal carrier speed of the work stage 45, and it is decreased in 9 cycle/second at a stroke when the work stage 45 approaches to the specified position. Besides, when the work stage 45 arrives there, the driving current is made in 0 cycle/second.

Next, an operating example of thus constructed machining line will be explained as follows.

When all parts are capable of automatic operation, the work carriers H1 to H4 in FIG. 1 keep an initial condition where the support table 10 is situated in the descent point p4 and the movable guide rail members 17, 18, 19 are situated in the neutral point p0. Then, the work w is fed to a fixed height of the carrier starting point of the first work carrier H1 by a not-illustrated arbitrary feed means, an operation starting command is inputted in the controller 56 of the work carrier H1 from a not-illustrated central controller.

Accordingly, all parts of the work carrier H1 operate as follows. When the support table 10 is situated in the descent point p4, the work stage 45 is displaced to the right from the neutral point p0 by the motor 16 and arrives at the carrier starting point. Here, the support table 10 is displaced to the ascent point p5 by the motor 9. During this displacement, the work stage 45 receives the work w situating to the fixed height of the carrier starting point. Then, it is displaced to the left by the motor 16 and arrives at the carrier finishing point as the support table 10 keeps in the ascent point p5. Here, the support table 10 is displaced to the descent point p4 by the motor 9. During this displacement, the work w on the work stage 45 is received by the public-known work-fixing device 6 inside the first machining center 1A and positionally fixed.

Thereafter, the work stage 45 is displaced to the right by the motor 9 and stops at the neutral point p0 as the support table 10 keeps in the descent point p4. This stopping state is kept until the next work is carried.

In the operation of thus work carrier H1, the present position of the work stage 45 in the left/right direction is judged according to the data detected by the rotary encoder 32. When the work stage 45 is judged to arrive near the carrier finishing point, the carrier starting point or the other stopping position, 9 cycle/second of the driving current is fed into the general motor 16 to rotate at extremely low speed. Besides, when the work stage 45 is judged to arrive there, 0 cycle/second of the driving current is fed into the motor 16 until the next left and right displacement to stop the rotations. Accordingly, the work stage 45 can be exactly and swiftly stopped at the carrier finishing point, the carrier starting point or the other stopping position.

In this case, since an overrun regulating operation due to the impact between the movable stopper member 52a or 52b and the fixed stopper member 52c is added to the carrier starting point or the carrier finishing point, the work stage 45 is exactly and swiftly stopped within ±0.4 mm of the lateral error. Besides, in case of the other stopping position, it is exactly and swiftly stopped within ±0.6 mm of the lateral error.

Here, the work w fixed on the work-fixing device 6 in the first machining center 1A has the first machining enforced. When the machining is finished, an operation starting command is inputted to the controller 56 of the second work carrier H2 from the not-illustrated central regulating device.

Accordingly, all parts of the second work carrier H2 operate in accordance with the first work carrier H1. When the support table 10 keeps in the descent point p4, the work stage 45 is displaced to the right and arrives at the carrier starting point. Here, the support table 10 is displaced to the ascent point p5. During this displacement, the work stage 45 receives the work w not fixed by the work-fixing device 6 in the first machining center 1A Then, the work stage 45 is displaced to the left as the support table 10 is situated at the ascent point p5 and arrives at the carrier finishing point. Here, the support table 10 is displaced to the descent point p4. During this displacement, the work w on the work stage 45 is received by the work-fixing device 6 in the second machining center 1B and positionally fixed. Thereafter, the work stage 45 is displaced to the right and stops at the neutral point p0. The stopping state is kept until the next work is carried.

Then, after the second work carrier H2 returns to the initial condition, the first work carrier H1 is allowed to carry and operates according to the operation starting command from the not-illustrated central regulating device similarly.

Here, the work w fixed on the work-fixing device 6 in the second machining center 1B has the second machining enforced. When the machining is finished, an operation starting command is inputted to the controller 5G of the third work carrier H3 from the not-illustrated central regulating device.

Accordingly, all parts of the third work carrier H3 operate in accordance with the second work carrier H2. The work w on the work-fixing device 6 in the second machining center 1B is fixed on the work-fixing device 6 in the third machining center 1C. Thereafter, the third work carrier H3 returns and stops to the initial condition, and the stopping state is kept until the next work is carried.

Then, after the third work carrier H3 returns to the initial condition, the second work carrier H2 is allowed to carry and operates according to the operation starting command from the not-illustrated central regulating device similarly.

The work w fixed on the work-fixing device 6 in the third machining center 1C has the third machining enforced. When the machining is finished, an operation starting command is inputted to the controller 56 of the fourth work carrier H4 from the not-illustrated central regulating device. Accordingly, all parts of the fourth work carrier H4 operate in accordance with the second work carrier H2. The work w on the work-fixing device 6 in the third machining center 1C is carried out at the fixed height of the carrier finishing point of the fourth work carrier H4.

Then, after the fourth work carrier H4 returns to the initial condition, the third work carrier H3 is allowed to carry and operates according to the operation starting command from the not-illustrated central regulating device similarly.

Besides, the fourth work carrier H4 under the initial condition has the carrier operation allowed after the work w carried out to the specified height of the carrier finishing point is displaced to different position. And, it operates according to the operation starting command from the not-illustrated central regulating device similarly.

Thus operations are repeated, and therefore, the work carrying and the work machining in the machining line are to be automatically performed.

When using time for the work carriers H1 to H4 in the machining line has passed, the floating clearance increases in an interlock between the driving pinion 27 and the movable rack 31, an interlock among the interlocking pinion 35a, the movable rack 37 and the fixed rack 38, and an interlock among the interlocking pinion 35b, the movable rack 39 and the fixed rack 40.

When the floating clearance increases, the work stage 45 misses the exactness for stopping position in the left/right direction. Accordingly, for example, when the floating clearance surpass 0.04 mm, the above-mentioned interlock needs to be adjusted so that it becomes less than 0.04 mm.

Management for this adjustment will be explained as follows.

First of all, when the floating clearance in the interlock between the driving pinion 27 and the movable rack 31 increases, its management will be explained. In FIG. 5, when the fixed bolt 29 is pulled out, a not-illustrated push-bolt is screwed in the bolt hole 28a and the cylindrical male wedge 28 is pulled and displaced from the driving pinion 27, thereby loosening fastening of the driving pinion 27 for the rotating central axis 26. Next, the driving pinion 27 is displaced to the forward f3 on the rotating central axis 26. As this displaced distance increases, the floating clearance gradually decreases in connection with the longitudinal inclinations of the tooth 27a and the tooth 31a. Then, when the floating clearance becomes less than 0.04 mm, the fixed bolt 29 is screwed, and the cylindrical male wedge 28 is jammed into the driving pinion 27 to fasten the driving pinion 27 to the rotating central axis 26.

Besides, in stead of thus management, the height of the movable rack 31 can be made suitably low by interposing a not-illustrated shim between the movable rack 31 and the plate member 30d.

When the floating clearance in the interlock among the interlocking pinion 35a, the movable rack 37, and the fixed rack 38 increases, the following management will be performed.

First of all, the interlocking pinion 35a is suitably displaced to the rearward f4 against the movable rack 37 and the fixed rack 28. Therefore, the frame member 43 and the fixed axis for front and rear 36a are removed, and the adjustable ring 42 is taken out and machined so that its thickness is suitably decreased. And then, the fixed axis 36a is re-fastened to combine all parts in the original state. According to this, the position of the interlocking pinion 35a changes by a decrease in the thickness of the adjustable ring 42, and the floating clearance in the upper and lower interlock decreases in connection with the longitudinal inclination of the tooth related to the interlock.

Since the floating clearance in the interlock between the interlocking pinion 35b and the upper movable rack 37 is usually different from that between the interlocking pinion 35b and the lower fixed rack 38, the upper and lower floating clearances are managed so as to agree. Therefore, the bolt 44 is pulled out, the eccentric cylindrical axis member 41b is rotatively displaced to a suitable direction around the fixed axis for front and rear 41a, the bolt 44 is re-screwed, and thus, the eccentric cylindrical axis member 41b is fixed on a suitable angle position.

In this case, when the lower floating clearance is larger than the upper floating clearance and the difference therebetween is comparatively small, as shown in FIG. 9B, the bolt 44 is inserted into the through hole e2 at the specified position of the frame member 43 and screwed in the thread hole c3 at the specified position of the flange c of the eccentric cylindrical axis member 41b. According to this, the eccentric cylindrical axis member 41b is fixed as it is rotated right from the standard position shown in FIG. 9A by a comparative large angle.

On the other hand, when the upper floating clearance is larger than the lower floating clearance, the eccentric cylindrical axis member 41b is rotated left therefrom and managed symmetrically with the above-mentioned case. In this way, the upper and lower floating clearances are made to closely resemble and less than 0.04 mm.

Besides, in stead of thus management, the heights of the movable rack 37 and the fixed rack 38 can be made to closely resemble in that of the interlocking pinion 35a by interposing shims between the movable rack 37 and the member 18b as well as between the fixed rack 38 and the member 15c.

When the floating clearance in the interlock among the interlocking pinion 35b, the vertical movable racks 39 and the fixed rack 40 increases, its management is substantially same as the management which is performed when the floating clearance in the interlock among the interlocking pinion 35a, the movable rack 37 and the fixed rack 38 increases. Accordingly, it will be performed in accordance with this management.

The above-mentioned example can be modified as follows.

The lateral displacement of either of the movable guide rail members 18, 19 or the work stage 45 may be regulated by changing the places for fixing the stopper members 52a, 52b, 52c. In this case, a stopper member may be provided between arbitrary two members among the movable guide rail members 18, 19 and the work stage 45 or between an arbitrary member among them and a place integrally with the support member 10 so as to impact each other.

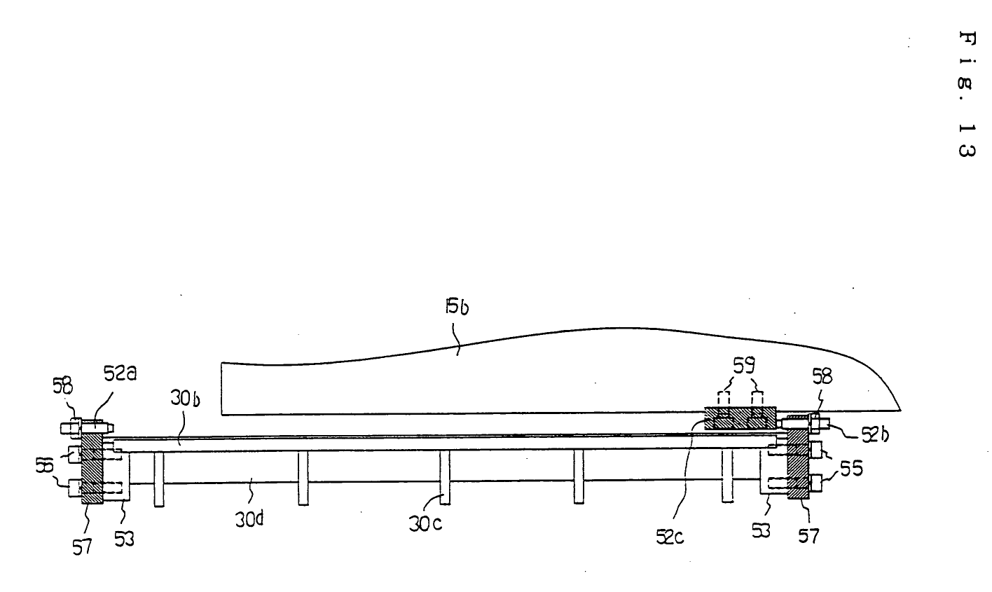

In stead of the above-mentioned stopper members 52a, 52b, a structure as shown in FIG. 13 can be done. That is, a member for front and rear 57 is fixed on each fixture 53, bolts for left and right serving as the stopper members 52a, 52b are screwed in the front ends of the members 57, 57, and lock nuts 58, 58 are screwed in the bolts 52a, 52b to fasten displacements thereof. According to this, it becomes easy to adjust the position of stopper members 52a, 52b.

Besides, in stead of the movable guide rail members 17, 18, 19 in triple, the middle movable guide rail member 18 can be made more than two stairs so as to form in more than quartet. In this case, the upper and lower contacting ones among these members are interlockingly connected in accordance with the interlocking connection among the interlocking pinion 35b, the movable rack 39 and the fixed rack 40. And when the lowest movable guide rail member 17 is laterally displaced against the fixed guide rail member 15, all movable guide rail members are interlocked so that the upper juts out more greatly to the left/right direction.

Moreover, it can be so constructed that the position of the eccentric cylindrical axis member 41b around the fixed axis for left and right 41a is modified in no stairs.

### INDUSTRIAL APPLICABILITY

According to the present invention, even if the general motor 16 is used in stead of the conventional servomotor, the work stage 45 can be displaced to the arbitrary position on the left/right direction with accuracy more than the equal against the conventional one. Concretely, for example, the work stage 45 can stop at the carrier starting point p1 and the carrier finishing point p2 with accuracy within ±0.4 mm, and besides, at the arbitrary position therebetween with accuracy within the ±0.6 mm.

Besides, it is unnecessary to provide with the stopper members 52a, 52b, 52c to the place except for the lowest movable guide rail member 17 and the support table 10. Therefore, it is possible to secure a space for the stopper members 52a, 52b, 52c easily, and it can be so constructed that the position can be adjusted in a wide place.

Moreover, it is possible to exactly stop the work stage 45 at the arbitrary position based on the data detected by the detector 32 regardless of the floating of the transmitting part of the reduction gear 20.

Furthermore, it is possible to easily increase and decrease the floating clearance in the interlock between the tooth 27a of the driving pinion 27 and the tooth 31a of the movable rack 31 due to modifying the longitudinal position of the driving pinion 27.

Besides, it is possible to decrease both of the floating clearance in the interlock between the lower tooth of an arbitrary interlocking pinion 35a or 35b and the tooth of the fixed rack 38 or the fixed rack 40 and the floating clearance in the interlock of the upper tooth of the arbitrary interlocking pinion 35a or 35b and the tooth of the movable racks 37, 39 in desirable size.

1. A work carrier, comprising:
a fixed guide rail member for left and right provided on a support table;
at least more than two movable guide rail members accumulated on the fixed guide rail member;
a drive unit for displacing the lowest movable guide rail member in a left/right direction;
a rail member interlocking mechanism for operating so that an upper movable guide rail member may greatly jut to the left/right direction in connection with movement of the lowest movable guide rail member in the left/right direction; and
a work stage moving in the left/right direction on the highest movable guide rail member in connection with its movement,
wherein the drive unit serves as a motor having a rotational speed being varied by inverter control and employing an open loop rotation control system, a plurality of stopper members are provided so as to impact each other to stop any of the movable guide rail members at positions corresponding to a carrier starting point and a carrier finishing point of the work stage, and the work stage is displaced to an arbitrary position between the carrier starting point and the carrier finishing point.

2. A work carrier as claimed in claim 1, wherein said plurality of stopper members comprise movable stopper members 52a, 52b fixed integrally with the lowest movable guide rail member 17 and a fixed stopper member 52c fixed integrally with a support table 10, and the lowest movable guide rail member is stopped at positions corresponding to a carrier starting point p1 and a carrier finishing point p2 on impact of the movable stopper members and the fixed stopper member.

3. A work carrier as claimed in claim 1, wherein said work carrier comprises a reduction gear 20 for being inputted rotation of an output axis of said motor, a driving pinion 27 interlockingly connected with an output axis 20a of the reduction gear 20 and freely rotated along a vertical surface for left and right at a specified position of the support table 10, a movable rack 31 long in a left/right direction interlocked with the pinion and fixed on the lowest movable guide rail member, and a displacement detector 32 for detecting an operating displacement of the output axis of the reduction gear on a path for communicating an operating displacement based on the rotation of the motor or an operating displacement in the arbitrary position by the side of a communicating displacement terminus from the output axis.

4. A work carrier as claimed in claim 3, wherein a tooth 31a of the movable rack is inclined in a front/rear direction of face width, and the driving pinion 27 serves as a bevel gear having a tooth 27a to be interlocked with the tooth of the movable rack, and said driving pinion 27 is fixed on a rotating central axis 26 to adjust a position in the front/rear direction.

5. A work carrier as claimed in claim 1, wherein said rail member interlocking mechanism is provided with a long fixed rack in a left/right direction fixed on said fixed guide rail member, movable racks long in a left/right direction respectively fixed on said movable guide rail members, and interlocking pinions 35a, 35b rotatably mounted around axes for front and rear at specified positions of the movable guide rail members except for the highest movable guide rail member, the tops and the bottoms of the interlocking pinions are interlocked with movable racks 37, 39 or fixed racks 38, 40, respectively, in this case, a tooth of said movable rack and a tooth of said fixed rack are inclined in a front/rear direction of face width, and the interlocking pinions serve as a bevel gear for engaging with the tooth of the movable rack, and besides, axes for front and rear 36a, 36b corresponding to the interlocking pinions are formed of fixed axes for front and rear 41a provided on the corresponding movable guide rail members 17, 18 and eccentric cylindrical axis members 41b external-insertedly fixed on the fixed axes for changeably adjusting angles around them, and moreover, the interlocking pinions adjust front and rear positions on the corresponding axes for front and rear, respectively.

6. A work carrier as claimed in claim 2, wherein said work carrier comprises a reduction gear 20 for being inputted rotation of an output axis of said motor, a driving pinion 27 interlockingly connected with an output axis 20a of the reduction gear 20 and freely rotated along a vertical surface for left and right at a specified position of the support table 10, a movable rack 31 long in a left/right direction interlocked with the pinion and fixed on the lowest movable guide rail member, and a displacement detector 32 for detecting an operating displacement of the output axis of the reduction gear on a path for communicating an operating displacement based on the rotation of the motor or an operating displacement in the arbitrary position by the side of a communicating displacement terminus from the output axis.

7. A work carrier as claimed in claim 2, wherein said rail member interlocking mechanism is provided with a long fixed rack in a left/right direction fixed on said fixed guide rail member, movable racks long in a left/right direction respectively fixed on said movable guide rail members, and interlocking pinions 35a, 35b rotatably mounted around axes for front and rear at specified positions of the movable guide rail members except for the highest movable guide rail member, the tops and the bottoms of the interlocking pinions are interlocked with movable racks 37, 39 or fixed racks 38, 40, respectively, in this case, a tooth of said movable rack and a tooth of said fixed rack are inclined in a front/rear direction of face width, and the interlocking pinions serve as a bevel gear for engaging with the tooth of the movable rack, and besides, axes for front and rear 36a, 36b corresponding to the interlocking pinions are formed of fixed axes for front and rear 41a provided on the corresponding movable guide rail members 17, 18 and eccentric cylindrical axis members 41b external-insertedly fixed on the fixed axes for changeably adjusting angles around them, and moreover, the interlocking pinions adjust front and rear positions on the corresponding axes for front and rear, respectively.

8. A work carrier as claimed in claim 3, wherein said rail member interlocking mechanism is provided with a long fixed rack in a left/right direction fixed on said fixed guide rail member, movable racks long in a left/right direction respectively fixed on said movable guide rail members, and interlocking pinions 35a, 35b rotatably mounted around axes for front and rear at specified positions of the movable guide rail members except for the highest movable guide rail member, the tops and the bottoms of the interlocking pinions are interlocked with movable racks 37, 39 or fixed racks 38, 40, respectively, in this case, a tooth of said movable rack and a tooth of said fixed rack are inclined in a front/rear direction of face width, and the interlocking pinions serve as a bevel gear for engaging with the tooth of the movable rack, and besides, axes for front and rear 36a, 36b corresponding to the interlocking pinions are formed of fixed axes for front and rear 41a provided on the corresponding movable guide rail members 17, 18 and eccentric cylindrical axis members 41b external-insertedly fixed on the fixed axes for changeably adjusting angles around them, and moreover, the interlocking pinions adjust front and rear positions on the corresponding axes for front and rear, respectively.

9. A work carrier as claimed in claim 4, wherein said rail member interlocking mechanism is provided with a long fixed rack in a left/right direction fixed on said fixed guide rail member, movable racks long in a left/right direction respectively fixed on said movable guide rail members, and interlocking pinions 35a, 35b rotatably mounted around axes for front and rear at specified positions of the movable guide rail members except for the highest movable guide rail member, the tops and the bottoms of the interlocking pinions are interlocked with movable racks 37, 39 or fixed racks 38, 40, respectively, in this case, a tooth of said movable rack and a tooth of said fixed rack are inclined in a front/rear direction of face width, and the interlocking pinions serve as a bevel gear for engaging with the tooth of the movable rack, and besides, axes for front and rear 36a, 36b corresponding to the interlocking pinions are formed of fixed axes for front and rear 41a provided on the corresponding movable guide rail members 17, 18 and eccentric cylindrical axis members 41b external-insertedly fixed on the fixed axes for changeably adjusting angles around them, and moreover, the interlocking pinions adjust front and rear positions on the corresponding axes for front and rear, respectively.
